(19) United States
(12) Patent Application Publication
(10) Pub. No.: US 2026/0112812 A1
(43) Pub. Date: Apr. 23, 2026

(54) ANTENNA DEVICE

(71) Applicant: Mitsubishi Electric Corporation, Tokyo (JP)

(72) Inventor: Takahiro HORIGUCHI, Tokyo (JP)

(73) Assignee: Mitsubishi Electric Corporation, Tokyo (JP)

(21) Appl. No.: 19/363,254

(22) Filed: Oct. 20, 2025

Related U.S. Application Data
(63) Continuation of application No. PCT/JP2023/025052, filed on Jul. 6, 2023.

(51) Int. Cl. H01Q 5/307; H01Q 1/46; H01Q 1/52

(52) U.S. Cl. CPC H01Q 5/307; H01Q 1/46; H01Q 1/526

(57) ABSTRACT

An antenna device includes: a housing provided with an antenna; a control board provided for the housing; a signal ground constituting a reference ground with respect to a circuit in the control board, and on which a wireless module connected with the antenna by a coaxial cable is mounted; a frame ground constituting a ground for the housing; a capacitor connecting the signal ground and the frame ground; a housing-side ground part grounding the coaxial cable; and a board-side ground part grounding the coaxial cable. A loop length of a closed loop passing through the housing-side ground part, the board-side ground part, the capacitor, and a connection part between the housing and the frame ground is a length less than a wavelength corresponding to a maximum transmission/reception frequency of the wireless module.

### CROSS REFERENCE TO RELATED APPLICATION

This application is a Continuation of PCT International Application No. PCT/JP2023/025052, filed on July 6, 2023, which is hereby expressly incorporated by reference into the present application.

### TECHNICAL FIELD

The present disclosure relates to an antenna device.

### BACKGROUND ART

In some antenna devices, a wireless module mounted on a control board, and an antenna are connected using a coaxial cable. In this case, the antenna device can obtain stable antenna characteristics by securing an earth. Such an antenna device is disclosed in, for example, Patent Literature 1.

### CITATION LIST

### PATENT LITERATURE

Patent Literature 1: JP 2007-158462 A

### SUMMARY OF INVENTION

### TECHNICAL PROBLEM

The antenna device disclosed in Patent Literature 1 includes a conductive sheet. One end of this conductive sheet is connected to an outer coating of the coaxial cable, and another end of the conductive sheet is connected to a conductor that is a ground for an antenna. Consequently, the antenna device disclosed in Patent Literature 1 can secure an earth with a simple configuration.

Here, in, for example, some antenna devices, one ground is separated into a ground on a control board side and a ground on a housing side, and these grounds are connected by a capacitor. When the outer coating of the coaxial cable and the ground of the housing are connected in such an antenna device including the two grounds, a large closed ground loop is formed across the outer coating of the coaxial cable, the ground of the control board, the ground of the housing, and the capacitor. Such a closed loop formed in the ground becomes an antenna for external noise, and superimposes the external noise on the coaxial cable. Hence, it is concerned that the reception sensitivity lowers.

The present disclosure has been made to solve the above problem, and an object of the present disclosure is to provide an antenna device that can suppress superimposition of external noise on a coaxial cable even in a case where the antenna device includes two grounds.

### SOLUTION TO PROBLEM

An antenna device according to the present disclosure includes: a housing provided with an antenna and formed using a metal material; a control board provided for the housing; a signal ground provided for the control board, constituting a reference ground with respect to a circuit in the control board, and on which a wireless module connected with the antenna by a coaxial cable is mounted; a frame ground provided for the control board, electrically connected with the housing, and constituting a ground for the housing; a capacitor electrically connecting the signal ground and the frame ground; a housing-side ground part provided for the housing, and fixing and grounding the coaxial cable; and a board-side ground part provided for the signal ground, and fixing and grounding the coaxial cable, and a loop length of a closed loop passing through the housing-side ground part, the board-side ground part, the capacitor, and a connection part between the housing and the frame ground is a length less than a wavelength corresponding to a maximum transmission/reception frequency of the wireless module.

### ADVANTAGEOUS EFFECTS OF INVENTION

According to the present disclosure, it is possible to suppress superimposition of external noise on a coaxial cable even in a case where an antenna device includes two grounds. Consequently, the present disclosure can prevent the reception sensitivity from lowering.

### BRIEF DESCRIPTION OF DRAWINGS

FIG. 1 is a schematic configuration diagram illustrating an electronic device to which an antenna device according to Embodiment 1 has been applied.

FIG. 2 is a perspective view of the electronic device to which the antenna device according to Embodiment 1 has been applied.

FIG. 3 is a perspective view illustrating a configuration of a housing-side ground part.

FIG. 4 is a perspective view illustrating a configuration of a board-side ground part.

FIG. 5 is a perspective view illustrating a configuration of the board-side ground part of the electronic device to which an antenna device according to Embodiment 2 has been applied.

### DESCRIPTION OF EMBODIMENTS

Hereinafter, a mode for carrying out the present disclosure will be described with reference to the accompanying drawings to describe the present disclosure in more detail. Note that the following embodiments will describe examples where an antenna device according to the present disclosure is applied to an electronic device 100.

### Embodiment 1.

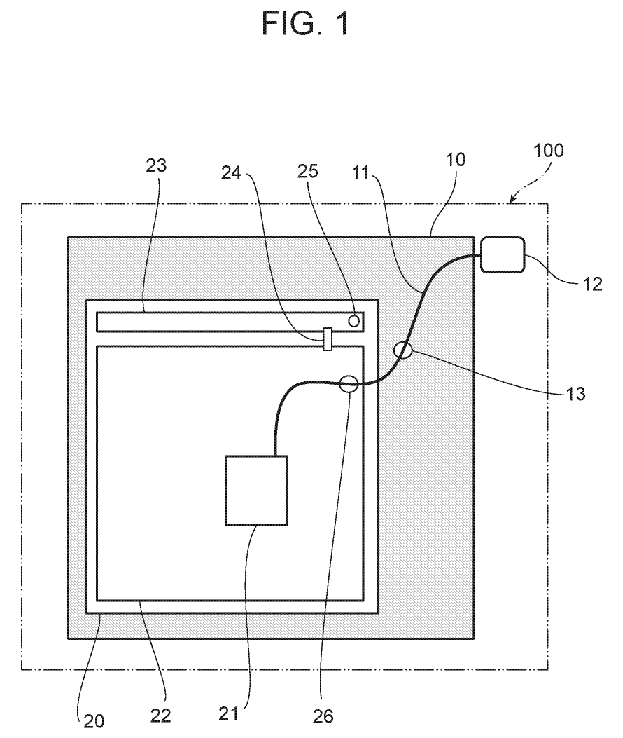

An antenna device according to Embodiment 1 will be described with reference to FIGS. 1 to 4.

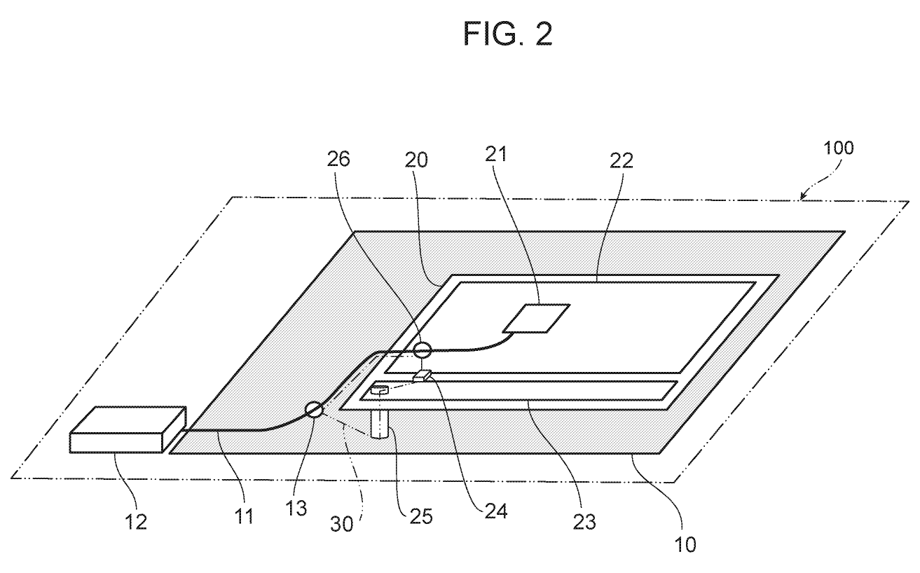

As illustrated in FIGS. 1 and 2, the electronic device 100 to which the antenna device according to Embodiment 1 is applied includes, for example, a housing 10, a coaxial cable 11, an antenna 12, a control board 20, a wireless module 21, and the like.

The housing 10 is formed using a metal material. This housing 10 includes the antenna 12 and a housing-side ground part 13. The antenna 12 and the wireless module 21 to be described later are electrically connected by the coaxial cable 11. The housing-side ground part 13 is a portion on which the coaxial cable 11 is grounded in the housing 10. Details of this housing-side ground part 13 will be described later.

The control board 20 is a circuit board. This control board 20 is attached to the housing 10. More specifically, the control board 20 is fixed to the same face as a face of the housing 10 provided with the housing-side ground part 13. Furthermore, the control board 20 includes the wireless module 21, a signal ground 22, a frame ground 23, a capacitor 24, a metal stud 25, and a board-side ground part 26.

The wireless module 21 is a transmission/reception module. This wireless module 21 is mounted on the control board 20 with the signal ground 22 interposed therebetween.

The signal ground 22 is a reference ground for a circuit in the control board 20 including the wireless module 21. The frame ground 23 is a ground for the housing 10. The signal ground 22 and the frame ground 23 are electrically connected with each other via the capacitor 24. Furthermore, the signal ground 22 and the frame ground 23 are provided on the same mounting surface of the control board 20. The size of the signal ground 22 is larger than the size of the frame ground 23, and occupies most of the above mounting face of the control board 20.

The frame ground 23 is electrically connected with the housing 10 via the metal stud 25. The metal stud 25 constitutes a connection part between the housing 10 and the frame ground 23. This metal stud 25 is formed in a columnar shape. One end of the metal stud 25 penetrates the control board 20 and the frame ground 23 in order so as to be electrically connected with the frame ground 23. The other end of the metal stud 25 comes into direct contact with the surface of the housing 10 so as to be electrically connected with the housing 10.

A connection point of the frame ground 23 and the one end of the metal stud 25, and an installation position of the capacitor 24 are brought close to each other as much as possible. Furthermore, a connection point of the housing 10 and the other end of the metal stud 25, and an installation position of the housing-side ground part 13 are brought close to each other as much as possible.

Note that the control board 20 is fixed to the housing 10 at multiple points, yet the housing 10 and the control board 20 are electrically connected only via the metal stud 25. Here, fixed points that do not establish electrical connection other than the metal stud 25 will be omitted.

The board-side ground part 26 is a portion on which the coaxial cable 11 is grounded on the control board 20. This board-side ground part 26 is provided on the surface of the signal ground 22. More specifically, the board-side ground part 26 is fixed to the same face as a face of the signal ground 22 provided with the wireless module 21. Details of this board-side ground part 26 will be described later.

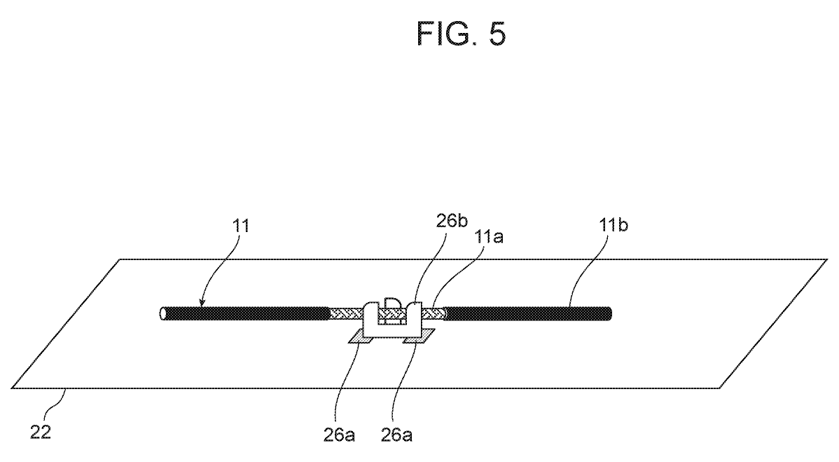

Here, for example, the coaxial cable 11 has a structure that surroundings of the center of a core wire (inner conductor) that is a signal line formed using copper or the like is surrounded by an insulation layer, a shield conductor layer (external conductor) 11a, and an insulation protective film 11b formed using an insulation material, in order (see FIG. 5). As described above, the coaxial cable 11 prevents leakage of an electrical signal flowing in the core wire to the outside and interference due to external noise (electromagnetic wave) from the outside by covering the core wire with the shield conductor layer 11a. Consequently, the coaxial cable 11 can suppress attenuation of the electrical signal and disturbance due to the external noise.

The coaxial cable 11 is fixed to the housing-side ground part 13 of the housing 10. More specifically, the coaxial cable 11 is fixed to the housing-side ground part 13 without exposing the shield conductor layer 11a in a state where the insulation protective film 11b is placed in contact with the housing-side ground part 13. The shield conductor layer 11a is not in contact with the housing 10 and the housing-side ground part 13. Hence, the coaxial cable 11 is grounded at a high frequency by an electrostatic capacitance produced between this shield conductor layer 11a and the housing 10.

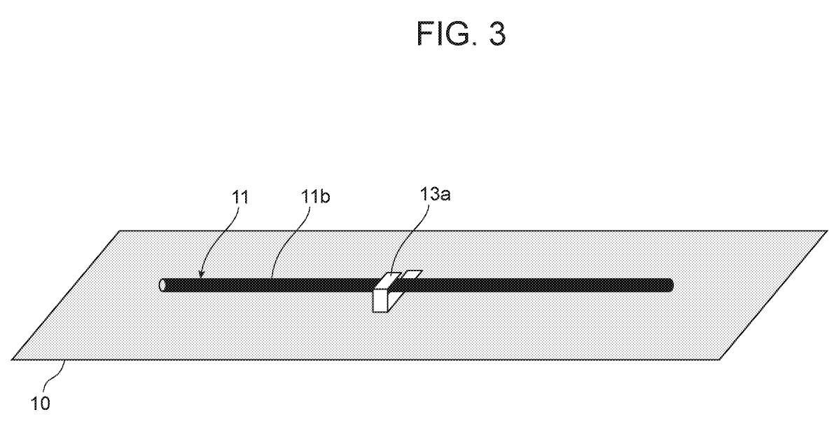

More specifically, as illustrated in FIG. 3, the housing 10 includes a cut-raised piece 13a as the housing-side ground part 13. This cut-raised piece 13a is formed by cutting and raising the housing 10. The coaxial cable 11 is grounded at a high frequency by being pinched between the surface of the housing 10 and the cut-raised piece 13a. That is, the cut-raised piece 13a constitutes a ground conductor.

Furthermore, the coaxial cable 11 is fixed to the board-side ground part 26 of the control board 20. More specifically, the coaxial cable 11 is fixed to the board-side ground part 26 without exposing the shield conductor layer 11a in a state where the insulation protective film 11b is placed in contact with the board-side ground part 26. The shield conductor layer 11a is not in contact with the signal ground 22 and the board-side ground part 26. Hence, the coaxial cable 11 is grounded at a high frequency by an electrostatic capacitance produced between this shield conductor layer 11a and the signal ground 22.

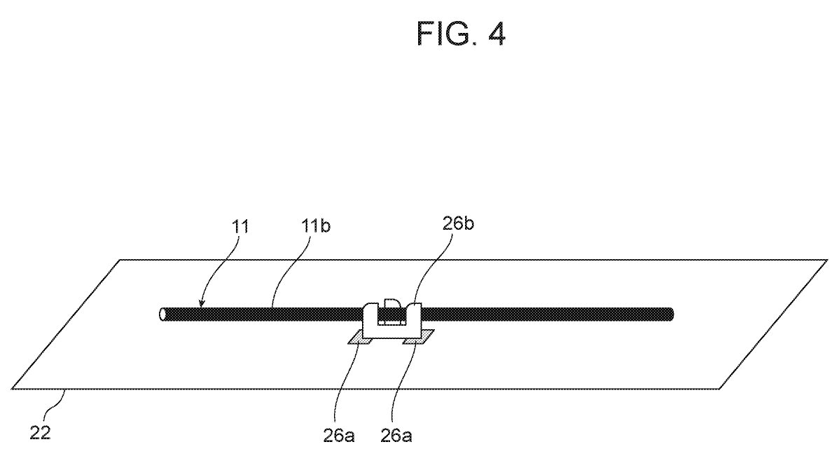

More specifically, as illustrated in FIG. 4, the signal ground 22 includes pads 26a and a clamp 26b as the board-side ground part 26. The pads 26a are formed using a conductive material. The pads 26a are provided on the surface of the signal ground 22. The clamp 26b is formed using a metal material. This clamp 26b is mounted on the surface of the pads 26a. The coaxial cable 11 is grounded at a high frequency by being pinched by the clamp 26b. That is, the pads 26a and the clamp 26b constitute a ground conductor.

Note that, although the cut-raised piece 13a and the clamp 26b are adopted as the structure of the respective ground parts for the coaxial cable 11, the structure is not limited to such a structure. The structure may be a structure that has an electrostatic capacitance that has a sufficiently low impedance in a use frequency band of the wireless module 21. For example, in the electronic device 100, the coaxial cable 11 may be fixed to the housing 10 and the signal ground 22 using a conductive tape.

Furthermore, as illustrated in FIG. 2, in the electronic device 100, installation positions of the housing-side ground part 13, the board-side ground part 26, the capacitor 24, and the metal stud 25 are set in such a way that a loop length of a closed loop 30 passing through the housing-side ground part 13, the board-side ground part 26, the capacitor 24, and the metal stud 25 is a length less than a wavelength corresponding to the maximum transmission/reception frequency of the wireless module 21. More specifically, in the electronic device 100, the loop length of the closed loop 30 which is formed along a creepage distance between the housing-side ground part 13, the board-side ground part 26, the capacitor 24, and the metal stud 25, by bringing these parts close to each other, can be set to the length less than the wavelength corresponding to the maximum transmission/reception frequency of the wireless module 21. Note that the maximum transmission/reception frequency of the wireless module 21 refers to a frequency that becomes maximum when the wireless module 21 transmits and receives radio signals.

Accordingly, a radio signal output from the wireless module 21 is sent through the coaxial cable 11, and is transmitted from the antenna 12. Furthermore, a radio signal having arrived from the outside is received by the antenna 12, then sent through the coaxial cable 11, and input to the wireless module 21. The wireless module 21 processes the input radio signal as a received signal.

Here, when external noise of the same frequency range as a frequency range of a transmitted radio signal or a received radio signal is produced near the electronic device 100, the closed loop 30 passing through the housing-side ground part 13, the board-side ground part 26, the capacitor 24, and the metal stud 25, as an antenna, receive the external noise. At this time, this received external noise is superimposed on the shield conductor layer 11a of the coaxial cable 11. As described above, the external noise superimposed on the shield conductor layer 11a of the coaxial cable 11 becomes a noise component for a regular radio signal and deteriorates the quality of the radio signal. As a result, it is concerned that the reception sensitivity of the wireless module 21 lowers.

By contrast with this, in the electronic device 100 according to Embodiment 1, the housing-side ground part 13, the board-side ground part 26, the capacitor 24, and the metal stud 25 are arranged in such a way that the loop length of the closed loop 30 is the length less than the wavelength corresponding to the maximum transmission/reception frequency of the wireless module 21. Generally, a resonance frequency of a loop antenna is an integer multiple of a frequency whose loop length is one wavelength.

As described above, although the closed loop 30 is the loop antenna including the shield conductor layer 11a of the coaxial cable 11, the loop length of the loop antenna is a length less than the wavelength corresponding to the maximum transmission/reception frequency of the wireless module 21. Hence, the resonance frequency of the loop antenna constituted by the closed loop 30 is set to a higher frequency side than the use frequency band of the wireless module 21. As a result, even when external noise of the same frequency range as a frequency range of a transmitted radio signal or a received radio signal is produced near the electronic device 100, the sensitivity of the loop antenna constituted by the closed loop 30 for this external noise becomes low. Consequently, superimposition of the external noise on the shield conductor layer 11a is suppressed.

As described above, the antenna device according to Embodiment 1 includes: the housing 10 that is provided with the antenna 12 and is formed using the metal material; the control board 20 that is provided for the housing 10; the signal ground 22 that is provided for the control board 20, constitutes the reference ground with respect to the circuit in the control board 20, and on which the wireless module 21 connected with the antenna 12 by the coaxial cable 11 is mounted; the frame ground 23 that is provided for the control board 20, electrically connected with the housing 10, and constitutes the ground for the housing 10; the capacitor 24 that electrically connects the signal ground 22 and the frame ground 23; the housing-side ground part 13 that is provided for the housing 10 and fixes and grounds the coaxial cable 11; and the board-side ground part 26 that is provided for the signal ground 22, and fixes and grounds the coaxial cable 11. In this case, in the antenna device, the loop length of the closed loop 30 passing through the housing-side ground part 13, the board-side ground part 26, the capacitor 24, and the connection part between the housing 10 and the frame ground 23 is the length less than the wavelength corresponding to the maximum transmission/reception frequency of the wireless module 21. Hence, the antenna device can suppress superimposition of external noise on the coaxial cable 11 even in a case where the antenna device includes the two grounds 22 and 23. As a result, the antenna device can prevent the reception sensitivity of the antenna 12 from lowering.

In the antenna device according to Embodiment 1, the coaxial cable 11 includes: the shield conductor layer 11a provided for the outer circumference of the core wire through which a radio signal passes; and the insulation protective film 11b provided for the outer circumference of the shield conductor layer 11a. In this case, the housing-side ground part 13 and the board-side ground part 26 ground the insulation protective film 11b. Hence, the antenna device can suppress superimposition of external noise on the coaxial cable 11 with a simple configuration.

The antenna device according to Embodiment 1 includes the metal stud 25 that electrically connects the housing 10 and the frame ground 23. Consequently, the antenna device can easily electrically connect the housing 10 and the frame ground 23.

In the antenna device according to Embodiment 1, the housing-side ground part 13 is the cut-raised piece 13a that is provided for the housing 10 and pinches the coaxial cable 11. Consequently, the antenna device can easily ground the insulation protective film 11b of the coaxial cable 11. As a result, the antenna device can ground at a high frequency the shield conductor layer 11a of the coaxial cable 11 on the cut-raised piece 13a that is the ground conductor.

In the antenna device according to Embodiment 1, the board-side ground part 26 includes: the pads 26a that are mounted on the surface of the control board 20; and the clamp 26b that is mounted on the surface of the pads 26a and pinches the coaxial cable 11. Consequently, the antenna device can easily ground the insulation protective film 11b of the coaxial cable 11. As a result, the antenna device can ground at a high frequency the shield conductor layer 11a of the coaxial cable 11 on the clamp 26b that is the ground conductor.

### Embodiment 2.

An antenna device according to Embodiment 2 will be described with reference to FIG. 5. Note that components having the same functions as those in above-described Embodiment 1 will be assigned the same reference numerals, and description thereof will be omitted.

As illustrated in FIG. 5, the coaxial cable 11 is fixed to the board-side ground part 26 in a state where the shield conductor layer 11a is placed in direct contact with the board-side ground part 26. More specifically, the insulation protective film 11b that is a portion corresponding to the board-side ground part 26 is removed from the coaxial cable 11, and the shield conductor layer 11a is exposed from the portion at which this insulation protective film 11b has been removed. Furthermore, the shield conductor layer 11a of the exposed portion is electrically grounded by being pinched by the clamp 26b mounted on the pads 26a.

Hence, the shield conductor layer 11a exposed from the coaxial cable 11, and the board-side ground part 26 are electrically conducted with each other. As a result, the exposed shield conductor layer 11a is grounded at a low impedance on the board-side ground part 26 in all bands including a low frequency band.

Note that, for the purpose of protecting the exposed shield conductor layer 11a, a metal member may be provided in such a way as to cover the surface of the exposed shield conductor layer 11a while being placed in contact with this exposed shield conductor layer 11a, and this metal member may be pinched by the clamp 26b. For example, in the electronic device 100, the exposed shield conductor layer 11a is protected by providing a metal sleeve as the metal member for the coaxial cable 11. Furthermore, in the electronic device 100, the sleeve is pinched by the clamp 26b in a state where the sleeve and the clamp 26b are conducted.

Here, electronic parts such as a Central Processing Unit (CPU) and a power supply Integrated Circuit (IC) are mounted on the control board 20, in addition to the wireless module 21. Hence, an operation of each electronic part may cause noise in a lower frequency band than a use frequency of the wireless module 21. In this case, when this noise propagates to the board-side ground part 26, the noise is externally radiated using the coaxial cable 11 as the antenna. Hence, the electronic device 100 may cause an Electromagnetic Interference (EMI).

By contrast with this, in the electronic device 100 according to Embodiment 2, the shield conductor layer 11a of the coaxial cable 11 is conducted with the board-side ground part 26, so that it is possible to return to the board-side ground part 26 the noise having propagated from the board-side ground part 26 to the shield conductor layer 11a of the coaxial cable 11. Consequently, in the electronic device 100, it is possible to suppress propagation of the noise produced at the control board 20 to the coaxial cable 11.

As described above, in the antenna device according to Embodiment 2, the coaxial cable 11 includes: the shield conductor layer 11a provided for the outer circumference of the core wire through which a radio signal passes; and the insulation protective film 11b provided for the outer circumference of the shield conductor layer 11a. In this case, the housing-side ground part 13 grounds the insulation protective film 11b, and the board-side ground part 26 grounds the shield conductor layer 11a exposed from the insulation protective film 11b. Consequently, the antenna device can suppress propagation of noise produced at the control board 20 to the coaxial cable 11 with a simple configuration.

In the antenna device according to Embodiment 2, the board-side ground part 26 includes: the pads 26a that are mounted on the surface of the control board 20; and the clamp 26b that is mounted on the surface of the pads 26a and pinches the coaxial cable 11. Consequently, the antenna device can easily ground the shield conductor layer 11a of the coaxial cable 11. As a result, the antenna device can conduct the shield conductor layer 11a of the coaxial cable 11 with the clamp 26b that is the ground conductor.

Note that the present disclosure enables free combinations of the embodiments, modification of any components in the embodiments, or omission of any components in the embodiments within the scope of the present disclosure.

### INDUSTRIAL APPLICABILITY

The antenna device according to the present disclosure can suppress external noise by making the loop length of the closed loop less than the wavelength corresponding to the maximum transmission/reception frequency of the wireless module even in a case where the antenna device includes the two grounds, and is suitable for use as antenna devices and the like.

### REFERENCE SIGNS LIST

10: housing, 11: coaxial cable, 11a: shield conductor layer, 11b: insulation protective film, 12: antenna, 13: housing-side ground part, 13a: cut-raised piece, 20: control board, 21: wireless module, 22: signal ground, 23: frame ground, 24: capacitor, 25: metal stud, 26: board-side ground part, 26a: pad, 26b: clamp, 30: closed loop, 100: electronic device

What is claimed is:

1. An antenna device comprising:
a housing provided with an antenna and formed using a metal material;
a control board provided for the housing;
a signal ground provided for the control board, constituting a reference ground with respect to a circuit in the control board, and on which a wireless module connected with the antenna by a coaxial cable is mounted;
a frame ground provided for the control board, electrically connected with the housing, and constituting a ground for the housing;
a capacitor electrically connecting the signal ground and the frame ground;
a housing-side ground part provided for the housing, and fixing and grounding the coaxial cable; and
a board-side ground part provided for the signal ground, and fixing and grounding the coaxial cable,
wherein a loop length of a closed loop passing through the housing-side ground part, the board-side ground part, the capacitor, and a connection part between the housing and the frame ground is a length less than a wavelength corresponding to a maximum transmission/reception frequency of the wireless module.

2. The antenna device according to claim 1, wherein
the coaxial cable includes: a shield conductor layer provided for an outer circumference of a core wire through which a radio signal passes; and an insulation protective film provided for an outer circumference of the shield conductor layer, and
the housing-side ground part and the board-side ground part ground the insulation protective film.

3. The antenna device according to claim 1, wherein
the coaxial cable includes: a shield conductor layer provided for an outer circumference of a core wire through which a radio signal passes, and an insulation protective film provided for an outer circumference of the shield conductor layer,
the housing-side ground part grounds the insulation protective film, and
the board-side ground part grounds the shield conductor layer exposed from the insulation protective film.

4. The antenna device according to claim 1, further comprising a metal stud electrically connecting the housing and the frame ground.

5. The antenna device according to claim 1, wherein the housing-side ground part is a cut-raised piece that is provided for the housing and pinches the coaxial cable.

6. The antenna device according to claim 1, wherein the board-side ground part includes:
a pad mounted on a surface of the control board; and
a clamp that is mounted on a surface of the pad and pinches the coaxial cable.
